(19) United States
(12) Patent Application Publication
(10) Pub. No.: US 2008/0222706 A1
(43) Pub. Date: Sep. 11, 2008

(54) GLOBALLY AWARE AUTHENTICATION SYSTEM

(76) Inventors: Martin Renaud, Maple Ridge (CA); Patrick Audley, Vancouver (CA); John Bradley, Vancouver (CA)

Correspondence Address: PERKINS COIE LLP;PATENT-SEA, P.O. BOX 1247, SEATTLE, WA, 98111-1247, US

(21) Appl. No.: 11/682,769

(22) Filed: Mar. 6, 2007

(51) Int. Cl. H04L 9/32

(52) U.S. Cl. 726/4

(57) ABSTRACT

A computer security monitoring method and system includes receiving input data, wherein the input data includes user account data associated with a user's security-related interaction with a particular network, security-related local network data associated with the particular network, and security-related external network data regarding security threats at one or more independent, external networks. The input data is analyzed to generate at least one composite security status score, wherein the analyzing includes an analysis of the user account data based on previously stored data associated with the user account, and an analysis of the security-related local and external network data to adjust the composite security status score when the analysis of the security-related local and external network data indicates an increased security threat. The method and system may produce human-readable output including an alert associated with the at least one composite security status score. Other features are disclosed.

### BACKGROUND

Security systems use authentication mechanisms to help protect valuable electronic information, restrict access to confidential areas, and to otherwise secure virtual or physical locations. These authentication mechanisms include passwords, cards (e.g., debit and credit cards with magnetic stripes, smart cards), etc, which are all designed to vet the identity of an individual user: if the user has the appropriate password, card or token, that user is considered legitimate. Because authentication mechanisms can routinely be compromised, many systems also employ authentication-monitoring methods that attempt to indicate fraudulent authentication attempts; for example, credit card companies employ a geographical tracking method that assesses the likelihood that a user would be authenticating from a particular location. These methods can quickly identify certain kinds of fraudulent authentication attempts, such as when an account is simultaneously accessed in both New York and Los Angeles; the system can decide that at least one of the transactions is fraudulent, and then notify the system administrator. Authentication monitoring methods such as geographical tracking are relatively easy to circumvent with proxy servers and numerous other techniques. In recent years fraudulent techniques have evolved and improved so that such simple detection methods are often inadequate on their own.

Authentication monitoring methods like geographical tracking offer the advantage of being minimally intrusive to legitimate users; the methods themselves are transparent to the user, imposing no additional restrictions, requirements, or risks. New techniques of fraud detection must also meet this bare minimum barrier to entry in the market: they must work efficiently and silently in the background, beyond the users awareness, and yet still guard effectively against fraud.

The technologies that are currently used to monitor and detect system threats are static and unresponsive to the daily changing threat levels in a system. The static criterion, are set long before the threat occurs, either on a weekly or daily basis rather than in real time. Modern computing speeds, however, enable a widespread multilayered attack to occur within hours or perhaps even minutes. Preset static criteria present a security risk that an attacker can capitalize on through strategic modification of the type of attack to determine the criterion and prepare a sophisticated learned attack strategy to gain entry. Multiple static criterions, for a range of simple security mechanisms, one of which may be geolocation tracking, present multiple targets for such a strategic attack. Security threats are routinely initiated as attacks directed at one or more levels within a network. A threat could be directed principally at a small number of accounts (as often happens in brute force password cracking), or could be directed system wide (as often happens with DOS (denial of service) and DDOS (distributed denial of service) attacks).

Overall, there is a need in the marketplace for new authentication monitoring technology that can detect and flexibly respond to threats that occur across numerous levels with the system, as well as respond to threats that occur outside of the system, to systems belonging to other related companies, report appropriately to the system administrator, and remain transparent to the user until notification is necessary.

### BRIEF DESCRIPTION OF THE DRAWINGS

FIG. 1 is a block diagram of a computer that may employ aspects of an authentication system.

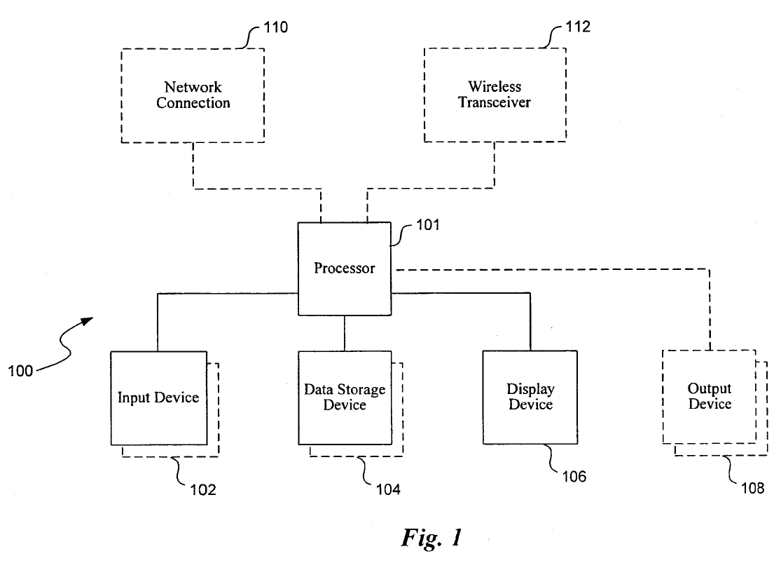

FIG. 2 is a block diagram illustrating a computing system in which aspects of the authentication system may operate in a networked environment.

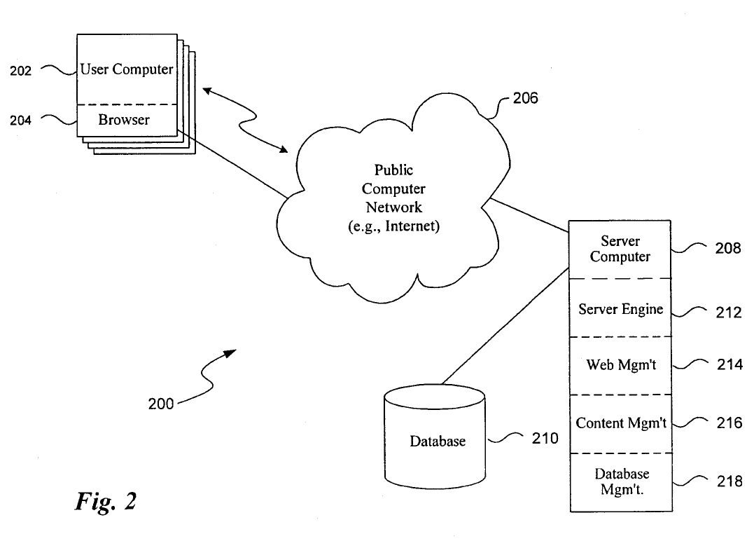

FIG. 3 is a representative display screen showing one embodiment of an administrative monitoring screen (including “Risk Monitor” and “Alert Status” displays) using a globally aware authentication system.

FIG. 4 is a representative display screen showing one embodiment of on-screen feedback, in which the globally aware authentication system provides login attempt data to the user.

FIG. 5 is a flow diagram of suitable steps that can be performed under one embodiment of the invention.

### DETAILED DESCRIPTION

A global attack may be preceded by a number of successful or unsuccessful local attacks, or even by seemingly unrelated metrics such as the ratio of authentication attempts to site bandwidth utilization. In addition, attacks against multiple companies within the same industry may simply serve as learning trials for the thief who eventually will be able to succeed against another company in the same industry, who has adopted similar types of technology to secure their network. Current security protocols and technology are inadequate for dealing with strategic, multilayered, multi-client attacks. Information and financial institutions are now searching for new methods to help ensure and maintain security. The system described below addresses these and other concerns.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

### I. REPRESENTATIVE COMPUTING ENVIRONMENT

The following discussion provides a general description of a suitable computing environment or system in which aspects of the invention can be implemented. Although not required, aspects and embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

The invention employs at least one computer, such as a personal computer or workstation, with at least one processor, and is coupled to one or more user input devices data storage devices. The computer is also coupled to at least one output device such as a display device, and may be coupled to one or more optional additional output devices (e.g., printer, plotter, speakers, tactile or olfactory output devices, etc.). The computer may be coupled to external computers, such as via an optional network connection, a wireless transceiver, or both.

The input devices may include a keyboard and/or a pointing device such as a mouse. Other input devices are possible such as a microphone, joystick, pen, game pad, scanner, digital camera, video camera, and the like. The data storage devices may include any type of computer-readable media that can store data accessible by the computer, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet. As will become apparent below, aspects of the invention may be applied to any data processing device. For example, a mobile phone may be secured with only the addition of software stored within the device—no additional hardware is required. The software may be stored within non-volatile memory of the phone, possibly even within the subscriber identity module (SIM) of the phone, or stored within the wireless network.

Aspects of the invention may be practiced in a variety of other computing environments. For example, a distributed computing environment including one or more user computers in a system, each of which includes a browser module. Computers may access and exchange data over a computer network, including over the Internet with web sites within the World Wide Web. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. Web browsers, or any application program for providing a graphical or other user interface to users, may be employed.

At least one server computer, coupled to a network, performs much or all of the functions for receiving, routing and storing of electronic messages, such as web pages, audio signals, and electronic images. Public networks or a private network (such as an intranet) may be preferred in some applications. The network may have a client-server architecture, in which a computer is dedicated to serving other client computers, or it may have other architectures such as a peer-to-peer, in which one or more computers serve simultaneously as servers and clients. A database or other storage area coupled to the server computer(s) stores much of the web pages and content exchanged with the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer may include a server engine, a web page management component, a content management component, and a database management component. The server engine performs basic processing and operating system level tasks. The web page management component handles creation and display or routing of web pages. Users may access the server computer by means of a URL associated therewith. The content management component handles most of the functions in the embodiments described herein. The database management component handles storage and retrieval tasks with respect to the database, queries to the database, and storage of data such as video, graphics and audio signals.

### II. SUITABLE IMPLEMENTATION AND OVERVIEW

One embodiment of the invention, described in detail below, is sometimes referred to as Globally Aware Authentication (GAA) or the “system” or “process”, which is a computer-implemented system that inconspicuously monitors and flexibly responds to security threats on multiple levels. It uses input from authentication mechanisms and/or authentication monitoring methods, as well as externally obtained data regarding known or suspected threats. Based on analysis of the input data, it scales the level of response and/or reporting according to the nature of the threat. This gives GAA the capability to provide: tailored responses to specific threats or specific locations; local protection in response to a global threat; and global response for threats to user accounts, even if only a few are currently under attack. It addresses the need for ongoing threat analysis at the local and global level, both of which a hacker may attempt to penetrate. Response and reporting are generated as output. GAA initiates threat reduction measures in systems that have variable levels of authentication requirements, increasing the requirements for individual verification on individual accounts (in response to an isolated local threat), and/or on all accounts (in response to a potential global threat.). Simultaneously, GAA informs system administrative personnel of threat type, risk level, and response. By circumventing the threat of fraudulent activity before it happens, the system described in detail herein also reduces the likelihood of gains from fraudulent attempts—and will thus reduce the attractiveness of this type of criminal activity to those likely to pursue it.

One aspect of the invention is a software based security process that can be loaded onto a server or other computer. It monitors threats against multiple levels across different systems, and tracks access attempts on all individual user accounts. The security process is able to monitor the flow of input information, noting any interruption or irregularity in the flow. No additional hardware is required.

At the global level, the security process ensures that a recognized attack on one part of the network or system escalates a risk level across the entire system. Each individual account retains a unique authentication profile, acting as a local security layer, which includes individual admission policies for each account or user. These admission policies are based on both the authentication profile itself, and on the characteristics of the account. This local profile may include characteristics such as a password hash that must be matched for successful login, user login history information to prevent simultaneous sessions and track historical patterns, as well as any additional authentication components that a client may adopt (e.g., fingerprint, cognitive biometrics, etc.). The authentication profile may also contain a globally aware component, which can impose or remove additional restrictions or requirements depending on the system-wide risk level. The authentication profile thus uses at least two layers of security, a local layer and a global layer, that synergistically adjust admission difficulty in the face of potential and/or real threats, vastly reducing the likelihood of a successful attack.

At a local level, user authentication patterns become security conditions that enhance the integrity of individual accounts: for example, the system may use typical location and login patterns (user location at log-in, and password attempts per day) to establish conditions for future entry. The system monitors future login attempts and compares them to historic norms. If the system identifies a noticeable increase in daily log in attempts, e.g., a number of attempts for a particular time and day exceeding a threshold norm, then the system could trigger a local alert. This alert, provided to all computers connected to the local network would require the user to input additional information prior to gaining access. The system could alternatively or additionally lock an account when multiple near-simultaneous access attempts are made to a single account from multiple locations. In such cases the system may advise the user to contact the system administrator for instructions or instruct all users on that account to enter additional authentication information so it can ascertain which login attempt is legitimate, and which is not.

In one embodiment of the invention, detection of multiple system penetration attempts (such as when a hacker or hackers attempt to access multiple points and generate a group of entry failures) will trigger a “multiple account failure” response. This response adjusts the risk level allocated to all accounts, and may include consequences such as: more stringent access requirements for all accounts (e.g., the user experiences normal authentication mechanisms, but the tolerance level for deviations from template performance may be reduced—a simple sensitivity adjustment that can be imposed on any biometric and most knowledge or token based systems); temporarily reduced account privileges (e.g., the user is able to conduct certain activities but is prevented access to higher risk transaction or highly sensitive information); or other response parameters as defined by a particular client institution.

The security process can adjust response and reporting on a geographical basis; if the system detects numerous access attempts from geographical locations corresponding to known threats, it can provide warnings and apply the appropriate response to the specific locations concerned. For example, multiple failed attempts from a location in Las Vegas might result in all transactions originating from that source to be held to a higher level of scrutiny than other locations. Users at certain previously identified “risky” locations could be temporarily asked to provide more information before being authenticated or simply be expected to more closely match their stored template (if a graded template form of authentication is in use) before being granted access. In other words, the authentication profile for users/accounts may include certain gathered responses (biometric, behavioral, physical, etc.) that form a computed norm or graded template, and a tolerance for deviations for future log on attempts may be narrowed when the risk level rises. See, e.g., U.S. Patent No. 60/797,718 (atty. docket no. 60783.8002.US00) by Martin Renaud, entitled SYSTEM AND METHOD ON ENHANCING USER AUTHENTICATION THROUGH ESTIMATION OF FUTURE RESPONSE PATTERNS, filed May 4, 2006.

Local security administrators would receive warnings, and privileges might be temporarily reduced for all local access attempts. In some embodiments, a potential threat may prompt security administrators to manually adjust the risk level of the system following particular policies adopted by the institution. In cases where a threat is reported (either in the media, through registered security agencies/fraud networks, via “word-of-mouth” among security experts, etc.) but which has not yet occurred in a particular system, the threat can be pre-empted by manually adjusting authentication requirements or tolerance for pattern deviation. The system could require, for instance, additional information at all local access points, or could reduce the type of access privileges allocated to specific sets of accounts, transaction types, etc. Such global awareness measures would have minimal or no impact on individual users, yet it would enhance users account and system security.

Global, multi-level monitoring allows the security process to provide a broad assessment of the likelihood that the clients' “local” network is at a higher than normal risk of penetration by any known threats in other foreign or independent networks. Such monitoring includes (but is not limited to) monitoring: IP address or network paths; geographic location; connection type (such as dial-up, cable modem, etc.); a signature of a machine being used to access (screen resolution, browser characteristics, secure data storage capabilities present, etc.); volume of global traffic as it relates to authentication attempts; volume of global hacking activities; time of day (for simultaneous, or near simultaneous access attempts to the system); pass/fail authentication attempts; etc.

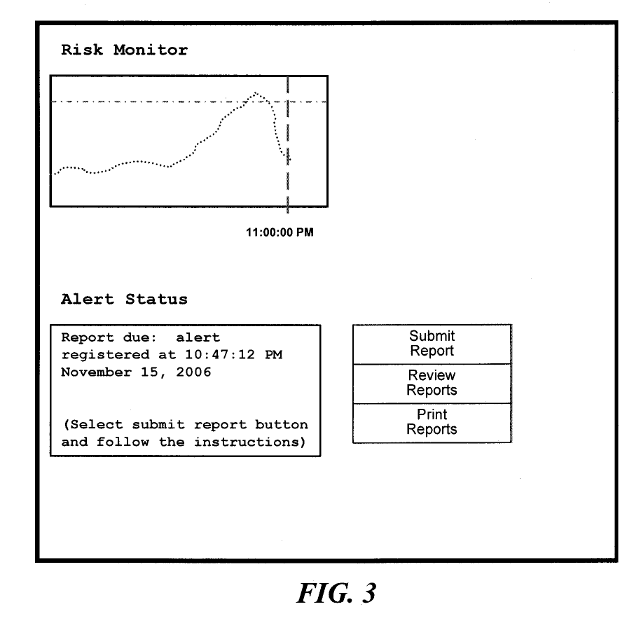

A noted herein, the security process contains a reporting component which functions separately at both global and the local security levels. At the global level, it provides an ongoing aggregate indication of the risk level for the whole system being monitored. In one embodiment this indication would take the form of a simple graded scale, like a meter, showing risk level as a point on an ordinal or interval scale (see FIG. 3). An administrator would see on the screen a near-real-time visual snapshot of the security level of the network, and an attempted breach of the network would cause this “risk meter” to immediately show a measured increase. Any form of visual feedback may be provided to the administrator, including graphs of network activity, etc. In another embodiment, the security process could cause a warning message to flash on the security administrator's screen, and might suggest both possible causes and courses of action that might circumvent the threat. This allows swift and appropriate action to forestall any further attacks. It also enables the security administrator to formalize a set of protocols for any security issue. Additionally, the system monitor could give administrators detailed information on the components of the system that were detecting the threat. For example, numerous failed logins, suggesting a brute force attack, could be indicated on the administrators screen so that specific measures could be taken to address that kind of attack. Early warning to this type of threat would enable administrators to look for weaknesses in the system as well as allow the administrators to monitor the system's ability to resist such attacks in real time.

The system integrates information from multiple sources by attaching a probability of risk measure to each component of a system. The risk level of an account is constructed by grouping all of these risk measures into a single weighted probability consensus function. The consensus function combines local and global risk measures and weighs each of these measures appropriately as defined by each institution. Such functions are often implicitly defined within the system. For example, a bank may have an authentication function that allows account access if a PIN is entered without deviation from the template or stored PIN for that account. The weighting of that function, therefore, is absolute (i.e., P(user)=1 or 0). In the current system, that absolute function would comprise only the first step of the authentication process. After passing that step (i.e., with P(User)=1), the function would continue by combining a Global risk (e.g., P(User) given global threats) and other forms of 2nd factor authentication whether biometric or cognitive (e.g., P(User) given biometric template or P(User) given Cognitive template). The result of the consensus function is a probability of the user after considering all of the information that has been considered. This function can be adapted to include any number of combinations of risk factors depending on the deployment environment of the system. The weighting functions can be modified automatically and/or manually following institution approved decision policies.

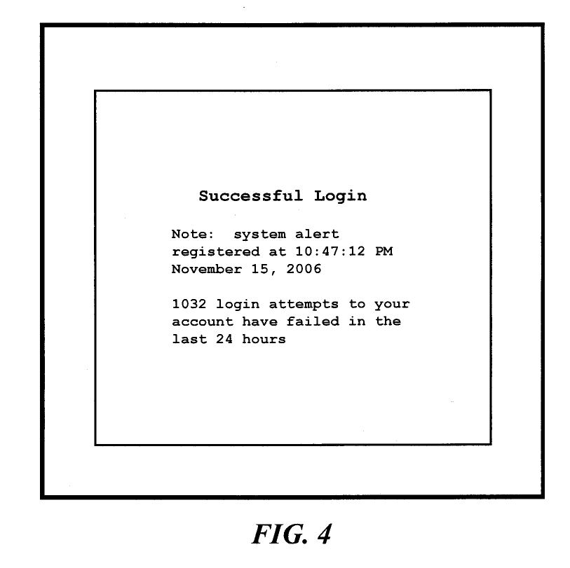

The security process also provides for feedback to individual users, indicating an existing security level for individual accounts immediately upon login. Feedback on individual accounts may be as simple as a message indicating the number of login attempts and/or failures within a given time period (see FIG. 4). For example, a user who had not accessed her account for a few days would immediately call the security administrator if, upon logging in, she saw that her account was accessed 20 times in the last 12 hours. Similarly, individual users may be provided with an indication of account security, analogous to the meter seen by the system administrators. If presented with this form of feedback, users will be more supportive of any increase in authentication requirements or deviation tolerance. In addition, informing users about security will make them more aware of ongoing threats, and of the importance of strong security. It is known that security training and education are ineffective on user behavior. The present system can permit fast, targeted and continuous training at every login, when user behavior is most likely to be affected by security related information. See also, e.g., U.S. App. No. 60/816,216 (atty. docket no. 60783.8005.US00) by inventors Martin Renaud, entitled SYSTEM AND METHOD FOR DYNAMICALLY ASSESSING SECURITY RISKS ATTRIBUTED TO A COMPUTER USER'S BEHAVIOR, filed Jun. 23, 2006.

An institution may want to determine if a session is being conducted by the person who initially passed authentication. In these situations, the client may not want to alert the user, since that may hamper investigations if the person pretending to be the user is actually an account hijacker: a form of “Man-in-the-Middle” attack where the data transmission is intercepted during the transaction. The attacker may wait until the user attempts to logout, block the logout request and continue their own activities using the open session. Currently the only method used to combat this attack is a session timeout after a certain number of minutes. In fact, most security experts consider the “Man-In-The-Middle” attack to be one of the hardest forms of online attack to prevent or even detect, until it is too late. The current system on the other hand, can be used to retest the authenticity of a user client, during a session, by gathering data from all sources except those requiring user input. For example, during a live session, the system could make a request through the connection for current geolocation, the user's device/computer profile information, as well as current fraud analytics available to the entire system (e.g., information from a fraud network, as noted below). A risk score can be recalculated based on these current values without interrupting the user from her online business. Upon noticing a discrepancy, the system could alert the system administrator and appropriate action can be taken based on the clients own threat policies. This would permit instant targeting and treatment of “Man-in-the-Middle” threats.

### III. EXAMPLE OF IMPLEMENTATION AND CALCULATIONS

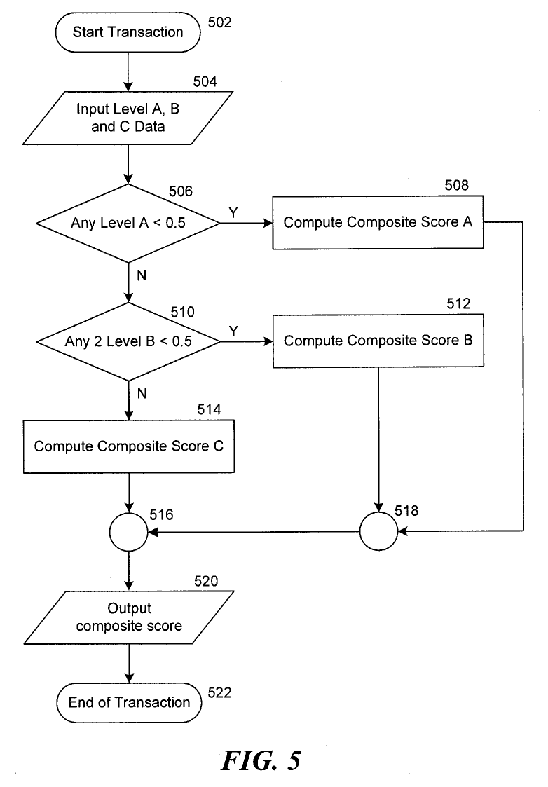

One example of a suitable embodiment of the invention will be described in connection with the flowchart shown in FIG. 5. It will be obvious to one skilled in the relevant art that this description is one of numerous potential ways the current system can be applied. Additionally, the data that serves as input to the system can be obtained from numerous sources, some of which are common to the area of online security, though other forms of data which are not common to online transactions, or that have not been used for this purpose as of yet can also serve as data input to the current system and the system would still function as has been described. For example, external information on potential or actual security threats may be obtained from fraud network MaxMind of Boston, Mass., which provides information on threats to other networks, independent of the network that the system is locally monitoring. Similarly, alternative embodiments can be envisioned that produce different data or summary outputs than those specifically described here.

The example below presents the situation of an online banking transaction, although the example could be expanded to authorizing any transaction or authentication attempt. The steps that the current embodiment of the invention proceeds through are characterized in the flow chart shown in FIG. 5. The transaction begins when the user accesses the bank's website and enters his bank card number or account number, and some form of password (block 502), which is compared to locally stored data in a database (account number and password or password hash). That initial data begins the GM process.

Under block 504, the process receives input data as it begins to generate a composite score. Data input at the beginning of this example transaction includes some or all data flowing through the network as a result of two machines in different parts of the world communicating. The data is segregated into separate levels of analysis. In the first or “Level A” data, the data includes location data of the user's machine/computer, identifying information from the user's machine (e.g., MAC address, etc.), and other forms of data that are commonly exchanged between distant computing devices, as well as temporal information indicating when the transaction started by the user and the duration of the current interaction. Input may also include information stored by the bank about the user's transaction history, including previous login time, account restrictions and any other relevant data. The same or a separate database is also queried to input additional information stored about the user. This database may hold information about the user's authentication templates and profiles, e.g., biometric template information like fingerprints, cognometric profiles, and any other profiles stored relevant to the bank. (Details on cognometric profiles may be found in U.S. application Ser. No. 11/608,186, filed Dec. 12, 2006, and entitled Authentication System Employing User Memories.) The results of the comparison and analyses of these additional profiles against the data entered by the user during the transaction are input to the system. Typically, these inputs are in the form of probability of a match between the stored data and the new data.

The system also obtains a global risk measure that can be either static (preset by the institution prior to the commencement of a day's business) or dynamic (reset and adjusted after each transaction to account for passed and failed authentication attempts.) This global risk factor allows the institution to adjust the barrier to entry into an account based on the general risk of doing business in an environment with a variable risk potential due to the inherent anonymity of online transactions. The global risk therefore provides a measure of the likelihood of any transaction being false, rather than a specific risk level for a particular user. This global risk measure may differ between institutions, e.g. be generally higher for financial or health care data (which requires a higher degree of security), and lower for other institutions, such as avocation or affinity-related institutions that handle data having lower regulatory/legal concerns.

The input data undergoes several stages of analysis. Each stage contributes to the final assessment of the truth of a user's identity claim using different portions of the input data. The first stage (block 506) uses simplest forms of data, “Level A” variables, (e.g., accuracy of knowledge base measures, simple timing measures and/or temporal overlap of consecutive transactions) to create a maximum probability level for a final output measure. Usually, a user will have accurate responses, where his timing will be within the normal range, and the account will not experience simultaneous attempted logins. Under these conditions, this first level of analysis will set the maximum possible outcome threshold at one (block 508). If instead, any one of these measures is problematic, (E.g., the user's accuracy is less than a probability of 0.5), then the user's maximum output measure will not be able to exceed 0.5 (i.e., the maximum threshold will be 0.5). All of the subsequent levels of analysis will be scaled using this maximum threshold.

If the maximum threshold has not been reduced at the first stage of analysis, it may still be reduced at a second stage. At this second level of analysis, a set of input measures are examined for unusual data entry behavior. Thus “Level B” variables can be examined, which may include a rate of data entry, rank order of selection times, mouse movement patterns, etc. These variables are examined for consistency with typical values or range of values for this user which are stored within his or her past history profile (and which may have been algorithmically adjusted (e.g., averaged) to produce the user's stored template). If any two of these “level B” data items have a probability of less than 0.5 (block 510) for this user, then the maximum threshold is adjusted (block 512). As well, if this condition occurs, the data items in first and third levels are averaged and scaled so that a maximum potential output measure cannot exceed 0.5. If the condition is not true, then the maximum output measure is not placed under any restrictions (maximum of 1.0).

Additionally, an average measure that results may be subjected to a correction or manipulation: it is multiplied by one or more global risk measures (block 514). The global risk measures may include any of those noted herein. This “Level C” variable can be a single global risk value or a combination of multiple values (appropriately scaled/normalized). If a risk of external threat is relatively low, then the global or external risk measure is close to 1, indicating little or no reduction in the averaged input values. If, on the other hand, the risk of external threat is high then the correction factor due to global risk will be substantially less than 1. Blocks 516 and 518 can thus represent threshold functions. Under an alternative embodiment, block 516 and/or block 518 can represent simple additions with appropriate changes to the values associated with each risk/security factor. Overall, the scores A, B and C, the thresholds, etc. are configurable by the system administrator.

In block 520, a composite score or output measure is produced. This single composite security level score can be easily appreciated and used by the administrator. The output score/measure may be sent to the client's decision policy engine to automatically adjust security levels/settings for users, as noted above. It can be used to assign account privileges based on concrete rules. For example, the client may decide that a high global assessment score permits full account access privileges. Low scores may result in account restrictions like allowing balances and pre-registered bill payments only.

The client may also decide that after full privileges have been awarded, a reanalysis of all of the data that does not require user intervention be conducted after the session duration reaches a certain point. The Global awareness engine can be set to automatically monitor the transaction, on a fixed schedule (e.g., every 10 seconds) to present a constant rating of the likelihood of transaction hijacking.

The client could also request additional authentication input from the user for certain types of transactions. The input data could then be reanalyzed and a new output measure computed. The barrier can be as flexible as the client desires simply by modifying which aspects of the data is included or excluded from the model. These and other alternatives are of course possible.

### IV. CONCLUSION

In general, the detailed description of embodiments of the invention is not intended to be exhaustive, or to limit the invention to the precise form disclosed above. While specific embodiments of, and examples for, the invention are described above for illustrative purposes, various equivalent modifications are possible within the scope of the invention, as those skilled in the relevant art will recognize. For example, while processes are presented in a given order, alternative embodiments may perform routines having steps in a different order, and some processes may be deleted, moved, added, subdivided, combined, and/or modified. Each of these processes may be implemented in a variety of different ways. Also, while processes are at times shown as being performed in series, these processes may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

The teachings of the invention provided herein can be applied to other systems, not necessarily the system described herein. The elements and acts of the various embodiments described herein can be combined to provide further embodiments.

These and other changes can be made to the invention in light of the above Detailed Description. While the above description describes certain embodiments of the invention, and describes the best mode contemplated, no matter how detailed the above appears in text, the invention can be practiced in many ways. Details of the system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I/We claim:

1. A method for computer-system authentication monitoring that can detect and report a response to both global unauthorized computer-access threats across independent, external networks and local unauthorized computer-access threats at a local network, while remaining transparent to individual users of the local network, the method comprising:
receiving input data, wherein the input data includes:
statistical information on authorized and unauthorized computer-access at the local network, wherein the statistical information includes both historical computer-access patterns and current computer-access attempts at the local network;
externally received information on potential and actual security threats at one or more of the independent, external networks; and
administrator-specified access metrics associated with the local network;
analyzing the input data to generate at least one security status parameter based on the analyzed input data, wherein the analysis is configurable by a system administrator associated with the local network;
producing human-readable output including:
alerts to users of the local network, and
reports to the system administrator associated with the local network; and,
providing scaled network security responses for at least the local network, wherein the scaled responses provide a higher degree of network access security measures to the users for accessing the local network when the at least one security status parameter indicates a higher network security threat, and a lower degree of network access security measures to the users for accessing the local network when the at least one security status parameter indicates a lower network security threat.

2. The method of claim 1, wherein the historical computer-access patterns include a number of attempts to access a selected electronic account, and wherein the current computer-access attempts includes approximately concurrent but geographically different access attempts to access the selected account.

3. The method of claim 1, wherein the externally received information on potential and actual security threats at one or more of the independent, external networks includes data received from an external system that gathers information on fraud attempts at networks external to the local network, and wherein the administrator-specified access metrics include a global measure that provides a weighting based on an institution employing the method.

4. A computer-readable medium storing computer-executable instructions that provide an electronic access authentication monitoring method associated with a specific network, the method comprising:
receiving data on authorized and unauthorized access attempts at the specific network, wherein the access attempts data includes both successful and unsuccessful access attempts to the specific network;
receiving at least one system administrator-specified value;
receiving external information on current, historical, or potential security threats associated with other networks;
storing the received data;
processing the access attempts data, the administrator-specified value, and the external information based on at least one configurable threshold; and
displaying security report information, including notifications and near real-time risk monitoring associated with the processing of the access attempts data, the administrator-specified value, and the external information, wherein at least some of the security report information is provided in a single display to at least a system administrator, and wherein the near real-time risk monitoring includes a display of a measure of a present security risk to the specific network.

5. The computer-readable medium of claim 4, further comprising:
providing at least one configurable, scaled response based on either temporarily increased authentication requirements for the selected network, or deviation from a previously stored tolerance for at least one user account; and,
monitoring time-sensitive, temporary changes to authentication requirements or deviation tolerances.

6. The computer-readable medium of claim 4 wherein the access attempts data includes a number of attempts to access at least one user account over a selected time period.

7. The computer-readable medium of claim 4 wherein the access attempts data includes data associated with approximately concurrent but geographically different access attempts to access at least one user account.

8. The computer-readable medium of claim 4 wherein the external data includes data received from an external fraud network data source that gathers information on fraud attempts at other networks.

9. The computer-readable medium of claim 4 wherein the administrator-specific value includes a global measure that provides a weighting based on an overall sensitivity of data associated with the specific network.

10. The computer-readable medium of claim 4 wherein the displayed notifications include warning messages regarding current threats to the specific network.

11. A computer security monitoring method, comprising:
receiving input data, wherein the input data includes:
user account data associated with a security-related interaction with a particular local network, and,
security-related network data regarding security threats at the particular local network or at one or more independent, external networks;
analyzing the input data to generate at least one composite security status score, wherein the analyzing includes an analysis of the user account data based on previously stored data associated with the user account, and an analysis of the security-related local or external network data to adjust the composite security status score when the analysis of the security-related local or external network data indicates an increased security threat;
producing human-readable output including:
an alert associated with the at least one composite security status score.

12. The computer security monitoring method of claim 11 wherein the user account data includes user behavior data associated with a security-related interaction with the particular network.

13. The computer security monitoring method of claim 11 wherein the security-related network data includes historical security-related interaction data of multiple users with the particular network.

14. The computer security monitoring method of claim 11 wherein the security-related network data includes data received by a system administrator of the particular network from system administrators of independent, external networks.

15. The computer security monitoring method of claim 11 wherein the method further comprises automatically increasing security measures for accessing the particular network based on the composite security status score.

16. The computer security monitoring method of claim 11 wherein the method further comprises retesting an authenticity of the security-related interaction with the particular network and gathering data from other sources except those requiring user input.

17. The computer security monitoring method of claim 11 wherein the method further comprises comparing current user input to a user profile for consistency with typical values or range of values for this user based on past authentication behavior.

18. The computer security monitoring method of claim 11 wherein the analyzing includes associating risk probabilities to at least some of the user account data and the local or external network data before generating the composite security status score.

19. The computer security monitoring method of claim 11 wherein the human-readable output includes providing a security related message to a user regarding a potential current security threat proximate to a user authentication session.

20. A computer security system, comprising:
input means for receiving input data, wherein the input data includes:
user account data associated with a security-related interaction with a particular network,
security-related local network data associated with the particular network, and,
security-related external network data regarding security threats at one or more independent, external networks;
processing, coupled to the input means, means for processing the input data to generate a security status score, wherein the means for processing includes means for analyzing the user account data based on previously stored data associated with the user account, and for analyzing the security-related local and external network data to adjust the composite security status score when the analysis of the security-related local and external network data indicates an increased security threat; and
output means, coupled to the processing means, for producing human-readable output including human-readable output associated with the at least one composite security status score.
